(19) United States
(12) Patent Application Publication
(10) Pub. No.: US 2013/0056156 A1
(43) Pub. Date: Mar. 7, 2013

(54) METHOD AND APPARATUS TO IMPROVE TAPE FEEDER HANDLING

(71) Applicants: W. Royce Taylor, IV, Nashua, NH (US); Ryan J. Koller, Bedford, MA (US)

(72) Inventors: W. Royce Taylor, IV, Nashua, NH (US); Ryan J. Koller, Bedford, MA (US)

(73) Assignee: Raytheon Company, Waltham, MA (US)

(21) Appl. No.: 13/223,483

(22) Filed: Sep. 1, 2011

(51) Int. Cl. B32B 37/00; F16B 45/00; F16B 1/00

(52) U.S. Cl. 156/538; 24/591.1; 24/592.1

(57) ABSTRACT

In one aspect, a device includes a member configured to engage a pivot pin disposed at an upper portion of a reel arm assembly of a tape feeder and allow the tape feeder to be lifted by a human hand.

In another aspect, a tape feeder includes a reel support section comprising a reel arm assembly and a member configured to engage a pivot pin disposed at an upper portion of the reel arm assembly and to allow the tape feeder to be lifted by a human hand.

### BACKGROUND

Electronic components (e.g., integrated circuits (ICs)) are supplied from vendors in tape-and-reel packaging. Typically, the electronic components are stored in cavities along a feeder tape and covered by a cover tape. The feeder tape is wrapped onto reels similar to movie film being wrapped on to movie reels making for easy storage.

A tape feeder is used to provide access to the electronic components for automated pick-and-place machinery used during the assembly process of Surface Mount Technology (SMT) circuit cards, for example. One of the critical functions of the tape feeder is to peel back the cover tape to expose the electronic components while feeding the electronic parts to the pick-and-place machinery.

### SUMMARY

In one aspect, a device includes a member configured to engage a pivot pin disposed at an upper portion of a reel arm assembly of a tape feeder and allow the tape feeder to be lifted by a human hand.

In another aspect, a tape feeder includes a reel support section comprising a reel arm assembly and a member configured to engage a pivot pin disposed at an upper portion of the reel arm assembly and to allow the tape feeder to be lifted by a human hand.

### DESCRIPTION OF THE DRAWINGS

FIG. 1 is a side view of a tape feeder with an ergonomic handle and a reel attached.

FIG. 2A is a side view of the ergonomic handle.

FIG. 2B is an angled view of the ergonomic handle.

FIG. 3 is a side view of a reel support section of the tape feeder before the ergonomic handle is attached and without a reel attached.

FIG. 4 is a side view of an upper portion of the reel support section before the ergonomic handle attached.

FIG. 5 is a side view of the upper portion of the reel support section with the ergonomic handle attached in a first position.

FIG. 6 is a side view of the upper portion of the reel support section with the ergonomic handle attached in a second position.

### DETAILED DESCRIPTION

Described herein is an ergonomic handle that may be added to a tape feeder to allow an operator to easily hold the tape feeder with two hands. The ergonomic handle in conjunction with an original handle also assists by distributing the weight of the tape feeder fairly evenly across the body of the tape feeder. The ergonomic handle further assists an operator by being easily accessible, especially for an operator that is short in stature. For example, when an operator loads or unloads the feeder to a feeder table it can be difficult for the operator to reach and access the original handle. The ergonomic handle is disposed substantially near the top of the tape feeder so that the operator can easily locate and grasp the ergonomic handle.

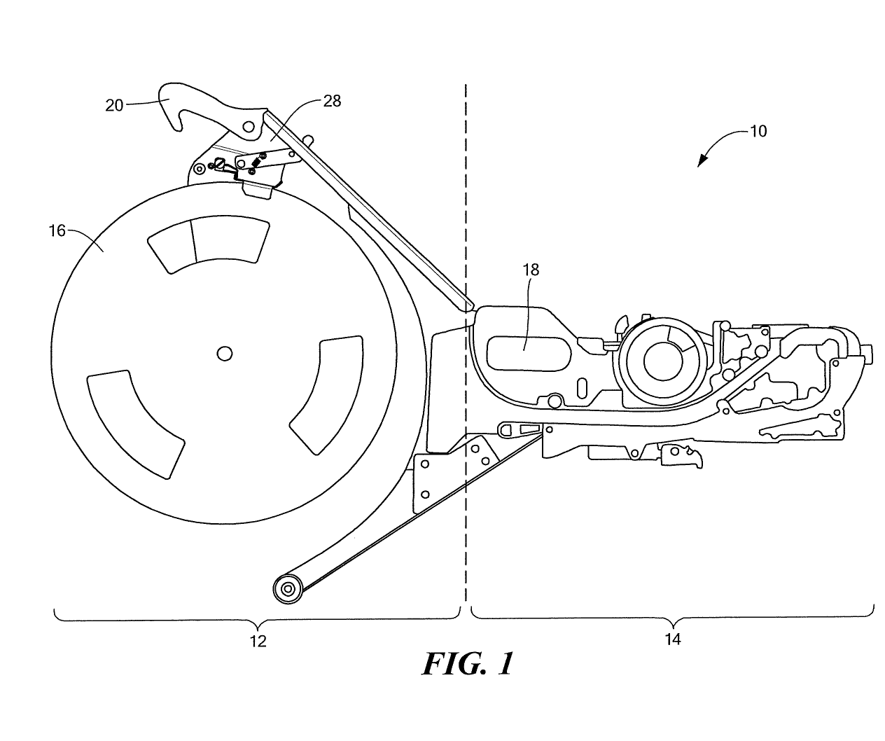

Referring to FIG. 1, a tape feeder 10 includes a reel support section 12 to hold a reel of feeder tape and a tape removal section 14. The tape removal section 14 includes a built-in handle 18 to allow an operator to hold the tape feeder. The tape removal section 14 removes a cover tape from the feeder tape to expose electrical components. The reel support section 12 supports a reel 16 of feeder tape. As will be further described below, the reel support section 12 includes an ergonomic handle 20 that may also be used with the built-in handle 18 by the operator to hold the tape feeder 10. The ergonomic handle 20 is attached to an upper portion 28 of the reel support section 12.

In one example, the tape feeder may be a tape feeder manufactured by JUKI® (e.g., FTF type (12 mm to 72 mm), FTFR 32/44/56 Type and so forth). In other examples, the tape feeder is one of JUKI® models: FF12NS, AF12NS, FF16NS, AF16NS, FF24NS, AF24NS, FF32FR, FF44FR, FF564R, FF568R, FF724S, FF728S and so forth.

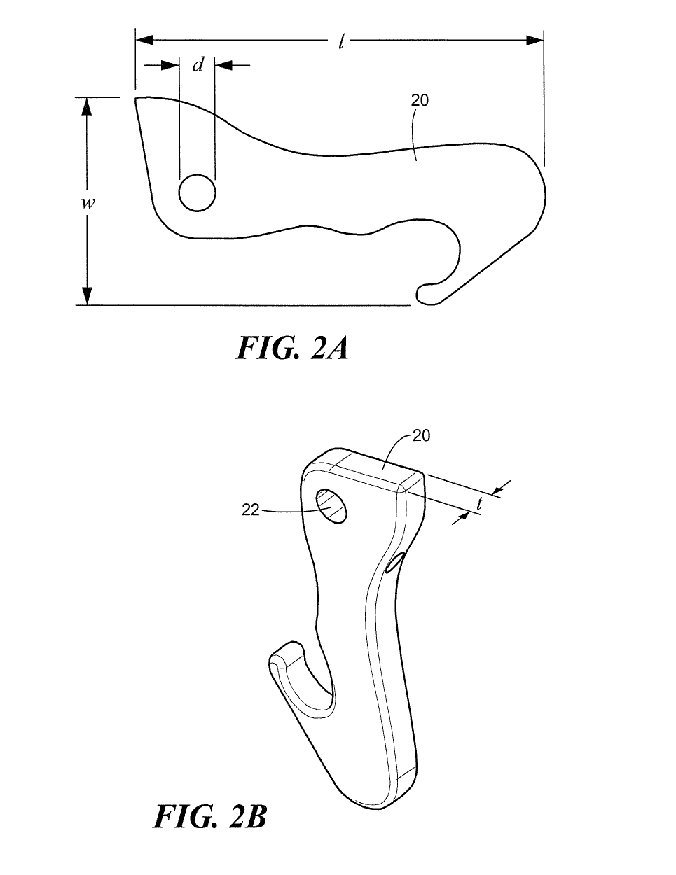

Referring to FIGS. 2A and 2B, the ergonomic handle 20 is a hook-shaped device with a thickness, t, a length, l, and a width, w. In one example, the thickness, t, is about 0.390 inches, the length, l, is about 4.4 inches and the width, w, is about 2.15 inches. The ergonomic handle 20 includes a bore 22 with a diameter, d. In one example, the diameter, d, is about 0.395 inches.

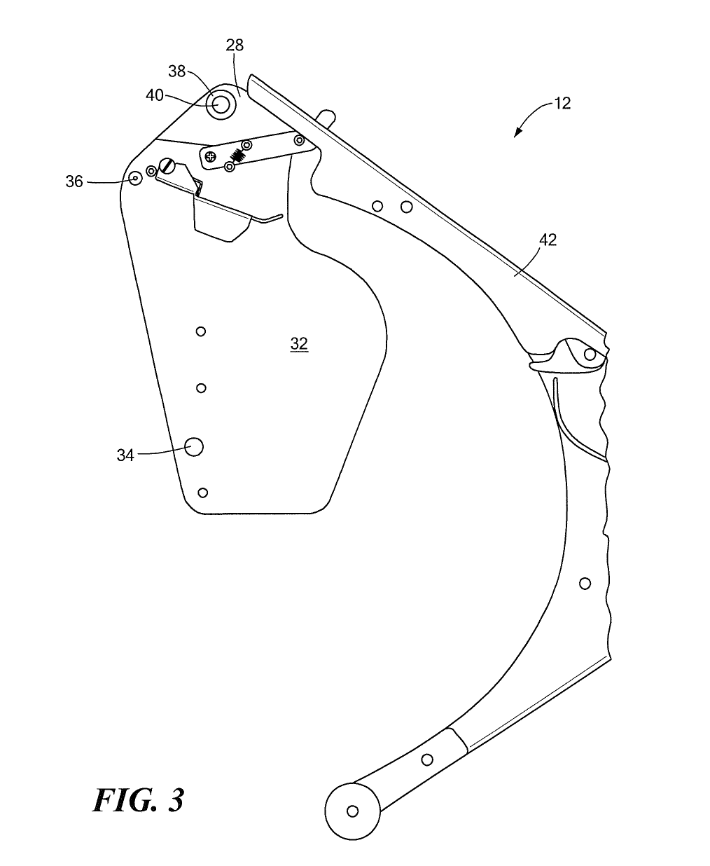

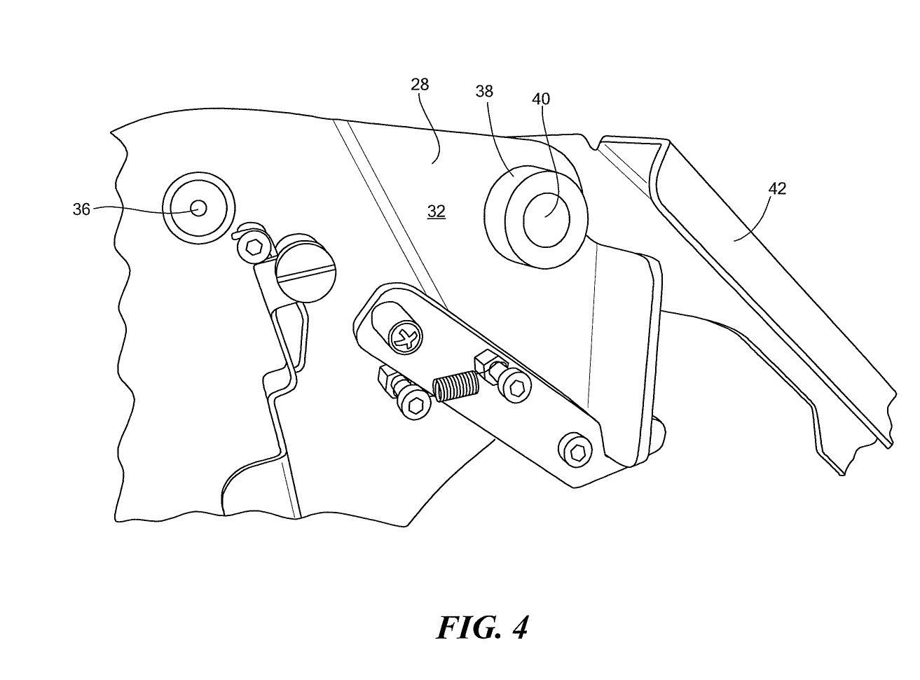

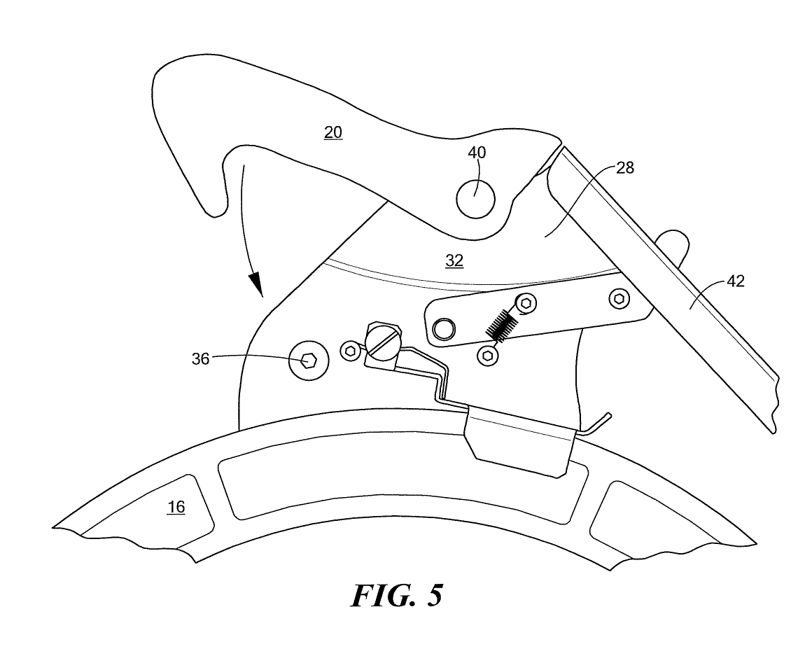

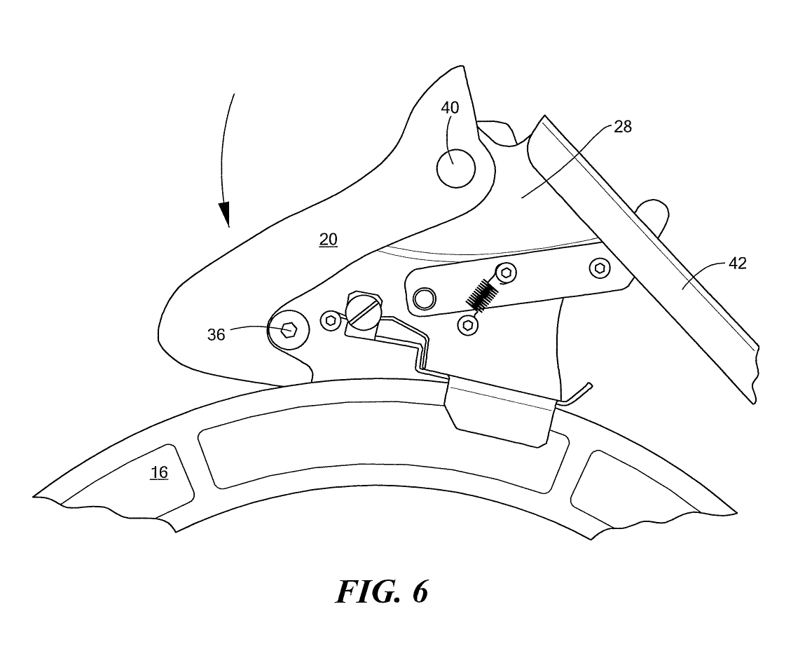

FIGS. 3 and 4 depict the reel support section 12 without the reel 16 attached and before the ergonomic handle 20 is attached. The reel support section 12 includes a reel arm assembly 32 that includes a reel hook shaft 34 and a reel support shaft 36. A support member 42 couples the reel arm assembly 32 to the tape removal section 14. The reel 16 is attached to and rotates about the reel hook shaft 34. The reel arm assembly 12 also includes a pivot pin 40 with a bushing 38 on the pivot pin 40. The reel arm assembly 32 rotates about the pivot pin 40. The bushing 38 may be removed and the ergonomic handle 20 may be attached to the pivot pin 40 as shown in FIGS. 5 and 6.

Referring to FIGS. 5 and 6, the ergonomic handle 20 is attached to the upper section 28 of the reel support section 12 on the reel arm assembly 32. In particular, the bore 32 engages the pin 40 attached to the reel arm assembly 32. As shown in FIG. 5, the ergonomic handle 20 is in a first position. In the first position, the operator can use the ergonomic handle 20 to lift the tape feeder 10. As shown in FIG. 6, the ergonomic handle 20 is in a second position out of sight when the tape feeder does not need to be lifted or carried. In the second position, the hook may engage the reel support shaft 36 to secure the ergonomic handle 20.

Elements of different embodiments described herein may be combined to form other embodiments not specifically set forth above. Other embodiments not specifically described herein are also within the scope of the following claims.

What is claimed is:

1. A device comprising:
a member configured to:
engage a pivot pin disposed at an upper portion of a reel arm assembly of a tape feeder; and
allow the tape feeder to be lifted by a human hand.

2. The device of claim 1 wherein the member is hook-shaped.

3. The device of claim 1 wherein the member comprises a bore configured to engage the pivot pin.

4. The device of claim 3 wherein the member is configured to rotate about the pivot pin.

5. The device of claim 4 wherein the member is configured to rotate to a first position to enable the tape feeder to be lifted.

6. The device of claim 5 wherein the member is configured to rotate to a second position different from the second position to engage a reel support shaft on the upper portion of the tape feeder.

7. The device of claim 3 wherein the bore has a diameter of about 0.395 inches.

8. The device of claim 3 wherein the thickness of the member is about 0.390 inches.

9. The device of claim 3 wherein the length of the member is about 4.4 inches and the width of the member is about 2.15 inches.

10. The device of claim 1 wherein the tape feeder is manufactured by JUKI®.

11. A tape feeder, comprising:
a reel support section comprising a reel arm assembly;
a member configured to:
engage a pivot pin disposed at an upper portion of the reel arm assembly; and
allow the tape feeder to be lifted by a human hand.

12. The tape feeder of claim 11 wherein the member is hook-shaped.

13. The tape feeder of claim 11 wherein the member comprises a bore configured to engage the pivot pin.

14. The tape feeder of claim 13 wherein the member is configured to rotate about the pivot pin.

15. The tape feeder of claim 14 wherein the member is configured to rotate to a first position to enable the tape feeder to be lifted.

16. The tape feeder of claim 15 wherein the member is configured to rotate to a second position different from the second position to engage a reel support shaft on the reel arm assembly.

17. The tape feeder of claim 13 wherein the bore has a diameter of about 0.395 inches.

18. The tape feeder of claim 13 wherein the thickness of the member is about 0.390 inches, the length of the member is about 4.4 inches and the width of the member is about 2.15 inches.

19. The tape feeder of claim 11 wherein the tape feeder is manufactured by JUKI®.

20. The tape feeder of claim 11, further comprising:
a tape removal section; and
a support member coupling the reel arm assembly to the tape removal section.
